(19) United States
(12) Patent Application Publication
(10) Pub. No.: US 2012/0131333 A1
(43) Pub. Date: May 24, 2012

(54) SERVICE KEY DELIVERY IN A CONDITIONAL ACCESS SYSTEM

(75) Inventors: Jiang Zhang, La Jolla, CA (US); Paul Moroney, La Jolla, CA (US); Petr Peterka, San Diego, CA (US)

(73) Assignee: General Instrument Corporation, Horsham, PA (US)

(21) Appl. No.: 12/952,792

(22) Filed: Nov. 23, 2010

(51) Int. Cl. H04L 9/00

(52) U.S. Cl. 713/156

(57) ABSTRACT

A method is provided by which a client device obtains authorized access to content delivered over a content delivery network. The method includes receiving an entitlement management message (EMM). The EMM includes at least one cryptographic key and a device registration server certificate ID (DRSCID) identifying a currently valid device registration server (DRS) public key certificate. The DRSCID obtained from the EMM is compared to a stored DRSCID value. An entitlement control message (ECM), which includes an encrypted traffic key for decrypting content, is received. If the DRSCID obtained from the EMM is determined to match the stored DRSCID, the traffic key is decrypted with the cryptographic key or a key derived from the cryptographic key to thereby access the content.

### FIELD OF THE INVENTION

The present invention relates generally to broadcast or other content delivery system systems such as a CATV system, and more particularly to a conditional access system employed in a content delivery system.

### BACKGROUND

Information broadcast systems include subscription-based systems in which a user subscribes to a system that provides programming or other content to the subscriber through a cable network or a satellite dish, for example. Since the programming is broadcast, it is transmitted once for receipt by all eligible receivers. Access to the data, however, is conditional, depending, for example, on whether or not a subscription fee has been paid for a specific receiver. Such conditional access to the content is realized by encrypting the information (usually the encryption occurs in the transmitter) under control of an authorization key and by transmitting the encrypted content to the receivers. Furthermore, the decryption keys necessary for the decryption of the content are encrypted themselves and transmitted to the receivers. Only those receivers that are entitled to the content are able to decrypt the decryption key.

Conditional access to content is provided by conditional access (CA) systems that come as matched sets—one part is integrated into the cable system headend (in a cable broadcast system) and encrypts premium content, the other part provides decryption and is built into the set-top boxes installed in user's homes. Several CA systems are used in the cable industry, including those provided by vendors such as Motorola (Schaumberg, Ill.), Scientific Atlanta (Atlanta, Ga.) and NDS (Staines, U.K.). Typically, the decryption mechanism is a dedicated encryption engine, e.g., an integrated circuit (IC) chip or dedicated hardware specifically designed to perform the decryption function. One example of a chip with this type of decryption capability is Motorola's MC 1.7 (MediaCipher v1.7) Conditional Access Control chip. All the cryptographic keys and the decryption functions are protected on this chip.

Key management in conditional access systems typically employ messages known as entitlement control messages (ECMs) and entitlement management messages (EMMs) to control access to data streams. EMMs are control messages that convey access privileges and cryptographic keys to subscriber devices. Unlike ECMs, which are transmitted in-band in the same multiplexed stream as the content with which they are associated, EMMs are typically sent unicast-addressed to each subscriber device. That is, an EMM is usually specific to a particular subscriber.

For example, typically, each subscriber receives an appropriate service key in an EMM based on his or her access type or level of service. For example, monthly subscribers to a channel receive an EMM which delivers a key valid for a full month, while subscribers to a smaller time portion of a channel or service would receive an EMM which delivers a less broad-in-time key, and pay per view subscribers would receive an EMM which delivers only the shortest time period program specific key.

Typically, the service keys (SKs) for the long-term subscription (e.g. the monthly subscription) normally need to change for every billing period so that the subscribers who stop paying the bill can be removed from the service, and these SKs need to be delivered to all devices once they change. In a one-way broadcast channel (e.g. satellite channel), the broadcasting server may not be able to identify if the receiving device has received the message. Therefore, in order to reach all devices reliably, it may re-broadcast the same message many times, which can consume a great deal of time as well as bandwidth. The bandwidth consumption is often problematic in many conditional access systems. Accordingly, it would be advantageous to provide a method and apparatus for delivering the service keys in an efficient manner to save bandwidth.

### SUMMARY

In accordance with one aspect of the invention, a method is provided by which a client device obtains authorized access to content delivered over a content delivery network. The method includes receiving an entitlement management message (EMM). The EMM includes at least one cryptographic key and a device registration server certificate ID (DRSCID) identifying a currently valid device registration server (DRS) public key certificate. The DRSCID obtained from the EMM is compared to a stored DRSCID value. An entitlement control message (ECM), which includes an encrypted traffic key for decrypting content, is received. If the DRSCID obtained from the EMM is determined to match the stored DRSCID, the traffic key is decrypted with the cryptographic key or a key derived from the cryptographic key to thereby access the content.

In accordance with another aspect of the invention, a system is provided which is configured to facilitate authorized access to content delivered to a plurality of client devices over a content delivery system. The system includes a client device registration server configured to broadcast to the client devices DRS public key certificates each containing a public key of the client device registration server and a DRSCID identifying the DRS public key certificate. The system also includes an entitlement management message (EMM) generator configured to provide EMMs to the client devices. Each EMM includes a service key or a list of service keys and a DRSCID identifying a currently valid DRS public key certificate that has been broadcast to the client devices. The system also includes an entitlement control message (ECM) generator configured to provide ECMs to the client devices over the content delivery system. Each ECM includes an encrypted traffic key for decrypting content. The encrypted traffic key is configured to be decrypted by an access key derived at least in part from the service key and the public key of the client device registration server.

In accordance with yet another aspect of the invention, a client device is provided which is configured to access content from a content delivery system. The client device includes a storage medium for storing a DRS public key certificate that includes a DRS public key and a DRSCID identifying the DRS public key certificate, a device certificate and a device private key. The client device also includes one or more modules configured to receive a first message containing a cryptographic key and a DRSCID identifying a currently valid DRS public key certificate and a second message containing an encrypted traffic key for decrypting the content. The client device also includes a unit key generating module configured to generate a unique unit using a cryptographic function on a private key of the client device and the DRS public key contained in the DRS public key certificate. The client device also includes a processor configured to compare the DRSCID contained in the first message to the stored DRSCID value and a decrypting module. The decrypting module is configured to (i) derive an access key from the cryptographic key if the DRSCID contained in the first message matches the stored DRSCID value (ii) to decrypt the encrypted traffic key using the access key and (iii) to decrypt the content using the traffic key.

### BRIEF DESCRIPTION OF THE DRAWINGS

FIG. 1 illustrates a block diagram of one example of a content distribution system.

FIG. 2 shows a process diagram by which the client device derives its unique unit key.

FIG. 3 shows a diagram of one example of a key hierarchy employed in a conditional access system.

FIG. 4 illustrates a flow diagram of one example of a method for providing authorized access to content to multiple client devices using system.

FIG. 5 shows one example of the pertinent components of a conditional access system.

FIG. 6 shows one example of the pertinent components of a client device.

### DETAILED DESCRIPTION

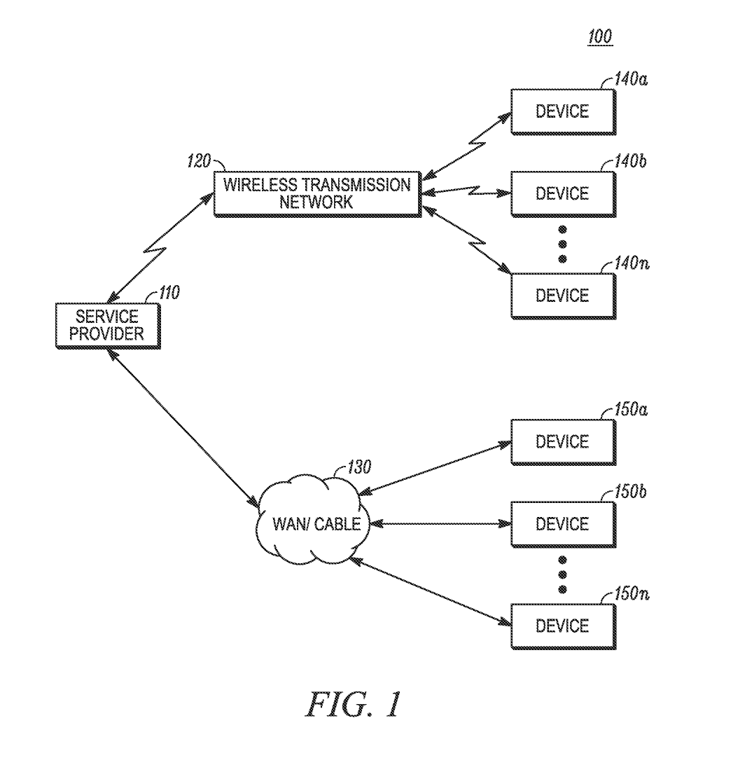

FIG. 1 illustrates a block diagram of one example of a content distribution system 100. In this example the illustrative system 100 includes a service provider 110, a wireless transmission network 120, such as a Wireless Wide Area Network (WWAN), WiMax, 3GPP, terrestrial or a satellite transmission network, and/or a landline transmission network 130, such as a Wide Area Network (WAN), DSL, fiber or a cable network. The system 100 also includes a plurality of client devices 140a-140n and 150a-150n for users to receive content from the service provider 110 via the satellite transmission network 120 and via the landline transmission network 130, respectively. As referred herein, content provided to users includes any audio or video data or information, such as streamed audio services, streamed video services, streamed data services or files that are broadcast using a protocol such as File Delivery over Unidirectional Transport (FLUTE). As also referred herein, a user or subscriber is an individual, a group of individuals, a company, a corporation, or any other entity that purchases, subscribes, or is authorized otherwise to receive access to one or more particular content services. Examples of users include but are not limited to Cable TV (CATV) subscribers, satellite TV subscribers, satellite radio subscribers, IPTV subscribers, and Pay-Per-View (PPV) purchasers of PPV events. As also referred herein, a PPV event is a particular content program for which a user requests access just before or slightly before such content is broadcast.

As further referred herein, a service provider is an individual, a group of individuals, a company, a corporation, or any other entity that distributes content to one or more users. Examples of service providers are CATV, satellite TV, satellite radio, wireless mobile service providers, as well as online music providers or companies. In turn, the service provider receives content from one or more content providers (not shown), such as film studios, record companies, television broadcasting networks, etc. It should be noted that a content provider is also operable as a service provider to directly provide its content to users in the same manner as shown for the service provider 110 in FIG. 1. As also referred herein, a client device is that device used to access content provided by a service provider (or content provider), which content the user has authorization to access. Examples of client devices include, but are not limited to set-top boxes (cable, satellite or IP STBs), CATV, satellite-TV, mobile handsets, and portable media players. It should be noted that a client device is operable as either a stand-alone unit (e.g., an STB) or an integral part of a content-viewing device, such as a television with a built-in satellite or CATV receiver.

Illustrative examples of the content delivery system 100 include, but are not limited to, broadcast television networks, cable data networks, xDSL (e.g., ADSL, ADLS2, ADSL2+, VDSL, and VDSL2) systems, satellite television networks and packet-switched networks such as Ethernet networks, and Internet networks. In the case of a cable data network, an all-coaxial or a hybrid-fiber/coax (HFC) network may be employed. The all-coaxial or HFC network generally includes an edge QAM modulator and a hybrid fiber-coax (HFC) network, for example. The edge modulator receives Ethernet frames that encapsulate transport packets, de-capsulate these frames and removes network jitter, implements modulation and, performs frequency up-conversion and transmits radio frequency signals representative of the transport stream packets to end users over the HFC network. In the HFC network, the transport stream is distributed from the headend (e.g., a central office) to a number of second level facilities (distribution hubs). Each hub in turn distributes carriers to a number of fiber nodes. In a typical arrangement, the distribution medium from the head-end down to the fiber node level is optical fiber. Subscriber homes are connected to fiber hubs via coaxial cables.

The content delivery system 100 may employ a conditional access system to limit access to content. Conditional access is performed in a number of distinct processes or layers. The first process is a registration process in which the client device registers with a device registration server (DRS) to establish secure communications between them. Before registration, the client device is loaded with a Root Certificate Authority (CA) public key. Optionally, the client device can be loaded with a DRS public key certificate as well. Among other things, the DRS certificate may include a DRS certificate ID (DRSCID), which is a unique identifier associated with the certificate. The certificate may also include the public key of the DRS. The DRS public key certificate is periodically broadcast to the client devices by the service provider.

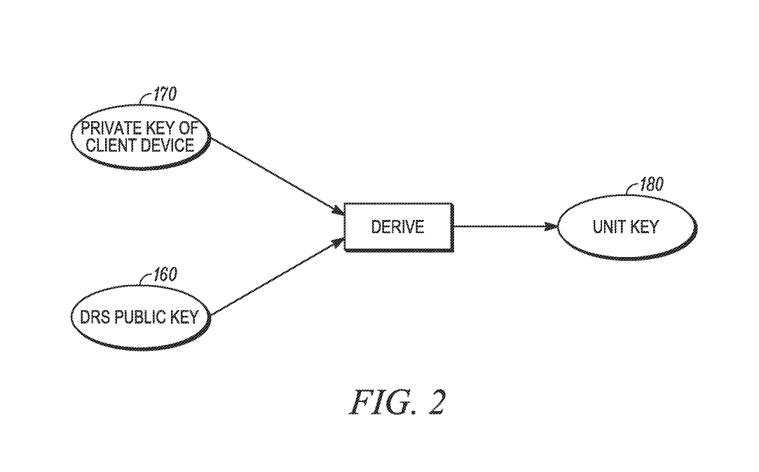

The client device can use the DRS public key available from the DRS certificate to derive its unit key, which is a symmetric key such as a 128 bit AES key that is unique to each client device. The unit key is used to derive the service keys, which will be described below. The unit key can be derived as shown in FIG. 2. In particular, a key generating module in the client device receives as input the DRS public key 160 and its own private key 170 to derive the unit key 180 using a key exchange algorithm such as a static elliptic curve Diffie Hellman (ECDH) algorithm, for example.

The DRS public key is a part of a DRS public/private key pair. The DRS uses its DRS private key, along with the public key of the client device, to derive the unit key. In this way both the DRS and the client device can derive the same unit key without the exchange of any private information that could compromise secure communication. However, because the DRS private key itself may be compromised in some manner, the DRS public/private key pair has to be changed once the key pair is compromised. In order to let new subscriber devices get the DRS public key as soon as possible, the DRS needs to periodically broadcast its DRS public key certificate to the client devices so that they can obtain the new DRS public key from it. To ensure that the client devices receive the new DRS certificate in time, the DRS may re-broadcast the same message multiple times. As previously mentioned, the conditional access system employs EMMs, which are the messages that deliver cryptographic keys such as service keys. Examples of service keys include a long-term key, a short-term key and a program key. To avoid confusion, it should be noted that the term “service key” is sometimes used in two different ways. In one case it refers to a key for any kind of service that is made available over the content delivery network. However, it sometimes is also used to exclusively refer to the long term key that is provided for subscription service only. An access key is derived from the service keys. The ECMs include an encrypted traffic key for decrypting the content that is transported in the same multiplexed stream as the ECMs. The traffic key is decrypted by the access key that is derived from the service keys included in the EMMs.

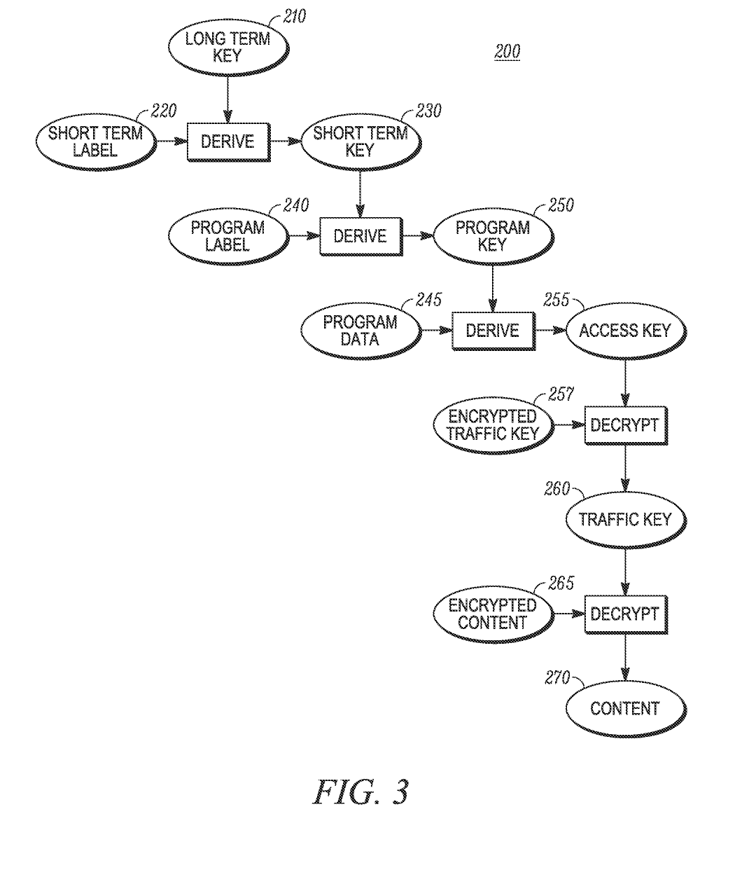

To use a single access key to encrypt a traffic key for all levels of service, a hierarchy of service keys may be used. FIG. 3 shows a diagram of one illustrative key hierarchy 200. Of course, other implementations may employ different key hierarchies or even simply a single service key.

Long-term key (LTK) 210 is a subscription service key that allows access to particular content for a specific length of time. Typically, the length of time is based on a monthly subscription schedule. However, the length of time may be longer than a month. The LTK 210 typically changes based on the designated billing cycle of every subscription (i.e., monthly) and is unique for each content service. A content service or service may be a single channel, and thus have its own long-term service key, or it may be a group of channels, such as the “basic” package, where the same LTK 210 service key is used for all channels within the basic package. As each subscriber may choose a different set of channels to view, multiple LTKs 210 may be delivered to the subscribers. For example, the channels in a basic service package may use the same long term key LTK0 210. HBO™ channels for premium service may use LTK1 210. As such, the basic service subscribers will get LTK0 210 only and the premium service subscribers will get both LTK0 210 and LTK1 210. In this example, all of the long-term keys are updated during each billing period. In addition, only the subscribers who continue their service subscription get the updated LTKs 210. If the user stops his subscription, the device will not receive the LTK 210 for that subscription. Consequently, the device will be unable to derive the program key and access the content.

In order to optimize delivery of the LTK 210 and save bandwidth, in some implementations a group key may be used to send the LTK 210. The group key is shared by a group of subscribers who have the same subscription plan. Once one group member drops out of the group, the group is dismissed and the remaining users are assigned to a new group having a new group key, which is distributed to each member.

The aforementioned unit key is used by the client device to decrypt the long term key or, if employed, the group key. In this way the long term key is protected during delivery to the client devices. The symmetric unit key 180 for each client device serves to reduce bandwidth usage and increases scalability for content security in comparison to a public key arrangement that does not employ such a symmetric unit key. For example, with purchased Pay-Per-View (PPV) events, unique program keys are delivered to each client device requesting this PPV event and are thus encrypted with the unique unit key 180 of each requesting client device. Otherwise, each program key must be encrypted and digitally signed with public key encryption, and the process is repeated for each such client device and each PPV content requested therein. Such heavy use of public key encryption requires high bandwidth usage between the service provider and the requesting client devices and causes scalability problems because it potentially and severely limits the number of client devices that can be authorized for the same PPV event.

The LTK 210 may be used to derive a short-term key (STK) 230, which allows access to content for a short period. STK 230 is only valid within a short-term subscription interval to provide the short-term subscription service, such as a one-day subscription (this is a variant of a pay-by-time service). The STK 230 would change in every short-term subscription interval and is also unique for each content service. The service provider may define the minimum time interval for short-term subscription, for instance, from 3 to 24 hours. If the short-term subscriber purchases multiple time intervals, multiple STKs 230 will be delivered to the short-term subscriber. Each STK 230 is associated with a different Short-Term Label (STL) identifier 220 and derived by the LTK 210 and STL 220. If the subscriber has selected short-term services on different channels, multiple STKs 230 may be delivered to that subscriber. In some implementations there may be multiple types of short-term keys, each allowing access to a different short-term service.

When a user receives an EMM containing the long term service key, the LTK can be identified by its service ID and a long term interval number or ID. This number or ID may start from 0 and increment by 1 for every long-term interval. The same service ID and number are delivered in the ECM corresponding to that service. The long term interval number or ID that is part of the service key ID may be specified in a service key list that is included in the EMMs. The ID of other service keys will generally be included in the service key list as well.

When a user receives an EMM containing an STK, the STK can be identified by the combination of the Service ID, and the long term interval number, and a short term interval number. This last number is an ID for each short-term interval within a long-term interval. In order to keep the messages compact, the long term and short term interval numbers may be kept as small as possible, which can reduce the bandwidth needed for EMM delivery. For instance, in some cases the long term interval number may be specified in one byte of data. In addition, the service key IDs listed in the service key list may all share the same long term interval number, which can further reduce the bandwidth needed for EMM delivery. It may start from 0 and increment by 1 for each short-term interval. Once a new long-term subscription period starts, it may be reset to zero and restart again. This short term number is also delivered in the ECM corresponding to that service.

When a user receives an EMM containing the program key, the program key can be identified by a channel number and a program number. The program number may start from 0 and is incremented by 1 for each program on a channel. When a new long term interval starts, it may be reset to zero and restart again. The channel number and program number are also delivered in the ECM corresponding to that service.

The Short-Term Label for a short-term subscription interval will be used in deriving the STK. It includes: (a) the service ID, (b) the long term interval number, and (c) the short-term interval number.

The STK derivation process uses the STL as input to an Advanced Encryption Standard (AES) encryption function, with the LTK as the encryption key. The resulting encrypted data is the STK. Users that receive the STK cannot reverse this process since they do not have the LTK. Therefore, by purchasing a short term service, a user cannot gain access to the higher level LTK and thus gain access to the entire service. Other one-way cryptographic functions may be used for deriving keys. Short-term subscribers receive the STK in their EMMs while long-term service subscribers have to derive the STK using the LTK they received in their EMM and the STL information received in the common ECM.

Continuing with reference to FIG. 3, The STK 230 may be used to derive a program key (PK) 250. The PK 250 is a key used to decrypt the traffic keys for each program. The PK 250 changes for each program. The PK 250 is also unique for each program and may be derived from the STK 230 using the Program Label (PL) 240 received in the ECM. The PL 240 includes a channel number and program number, and possibly other program related information. A short-term subscriber may derive a program key 250 using the STK 230 to get traffic keys (TKs) 260. Finally, the TK 260 is the key to decrypt the content 270. The TK 260 may change as often as once every second.

Users that purchased a single program will receive the PK in their EMMs while long-term and short-term service subscribers have to derive the PK using the STK they derived from the LTK or received in their EMMs, respectively, and the PL information received in the common ECM.

The PK derivation process uses the PL, including optionally some other service or program related data, as an input to an AES encryption function, using the STK as the encryption key. The resulting encrypted data is the PK. Users that receive the PK cannot reverse this process since they do not have the STK. Therefore, by purchasing a single program (or event), a user cannot gain access to the higher level keys such as the STK or LTK and thus gain access to content he did not pay for.

Note that the TK in the ECM may not be encrypted by the PK directly. Instead, there may be an intermediate key called the access key 255 which decrypts the encrypted TK. The access key is used to enforce the validation of Copy Control Information (CCI), Program Control Information (PCI), and other digital rules that are sent in the ECMs. The access key is derived from the PK and the CCI, PCI and other digital rules for the program. If the program's digital rules change during the program, the access key may change accordingly, but the PK is not required to change. The access key allows the content provider to define content rules freely without adding to the cost of the conditional access system to distribute additional PKs to the client device. If an access key were not employed, the CCI and other rules would essentially be fixed for the entire duration of the program, as the CCI and rules verification would be part of the program key derivation. Accordingly, in this case, the PL includes the program number and the channel number, while any other program related data, such as the aforementioned CCI, PCI and Blackout Information (BI) (if present), is input into another AES based key derivation step as program data 245. This derivation is designed to provide CCI, PCI, and BI authentication for the ECM messages.

Program data 245 can in general be extended to include any data that needs to be authenticated for the content or program. As shown, by way of example, the program data 245 is used in conjunction with the program key 250 to derive the access key 255. Using the access key 255, the encrypted traffic key 257 may be decrypted to get the TK 260 and using the TK 260, the encrypted content 265 may be decrypted and a user may access the content 270.

In the particular example of the key hierarchy described above, three levels of services have been described: long-term subscription, short-term subscription and PPV. Each service level has different EMMs, which include Long-term subscription EMM, Short-term subscription EMM, and PPV EMM. The Long-term subscription EMM has to be delivered to all subscribers every month. By way of example, if the service provider has tens of millions of subscribers and each message has to be broadcast many times, vast amount of bandwidth will be required. The short-term subscription EMM is only delivered to the short-term service subscribers after they have purchased short-term subscription service. The short-term subscription EMM includes the STL 220 and the STK 230 for the time intervals that the purchaser is allowed to access the content. Here the STL 220 is used as an ID for the STK 230. The PPV EMM is only delivered to PPV users after they have purchased the PPV service. The PPV EMM includes the PL 240 and the PK 250 for the program the user purchased. Here the PL 240 is also used as an ID for the PK 250.

It should be noted that in other implementations the key hierarchy may employ different numbers and types of service levels from those described above.

As previously mentioned, the client device's unit key, which is used to protect the service keys during delivery, may need to be changed because the DRS public key may be changed if the DRS private key is compromised or for some other reason. Since the DRS delivers new DRS public keys in the DRS public key certificate, new certificates will need to be periodically broadcast to the client devices. When a new DRS public key certificate is issued, it will receive a new DRSCID. The DRSCID may be formed from any appropriate identifier. For instance, in one example, the DRSCID is composed of a 14 bit identifier for the DRS and a 2-bit certificate revision number. In this example, the certificate revision number may be incremented by one when a new DRSCID is issued.

Normally those EMM messages encrypted using the unit keys will consume substantial amounts of bandwidth because they are individually sent to each device and they may need to be repeated multiple times to ensure that the message is being received and used by each client device. For instance, if there are 10 million client devices, then each additional re-transmission requires the transmission of 10 million additional messages. Thus, it would be advantageous to reduce the number of such EMM messages that need to be sent, while also making each message as small as possible.

Generally the EMM messages are placed in a re-broadcasting queue so that they can be repeatedly sent to the client devices.

However, instead of simply repeatedly sending the same message to increase the likelihood of its receipt, a more efficient approach would be to require the client device to confirm that it has received it, at which point it can be removed from the re-broadcasting queue. In this way the number of EMM messages that need to be sent can be reduced.

One way to notify the client device that it is using the correct DRS public key is by including the DRSCID in some or all of the EMMs that are sent to the client device. That is, the EMMs will now include a service key (e.g., a long-term key, short-term key or a PPV key) and the DRSCID of the currently valid DRS public key certificate. The currently valid DRS public key certificate is a DRS public key certificate that includes a public key that is part of a DRS public/private key pair having a private key that is currently being used by the client device registration server to derive the unique unit key associated with each of the client devices. By comparing the DRSCID of the DRS public key certificate that the client device is currently storing with the DRSCID included in the EMMs, the client device can determine if the DRSCID (and hence the DRS public key) has changed. If they match, then the client device knows it is using the correct DRS public key and hence the correct unit key. If however, the DRSCIDs do not match, the client device knows that it needs a new, updated DRS certificate.

In the message that delivers the DRS certificate, the DRSCID may have a digital signature signed by the DRS using the DRS's private key. If the DRSCID is digitally signed the client device will be required to validate it using the DRS's public key. Those EMMs having a digitally signed DRSCID may be referred to as DRS-EMMs.

In some implementations, to further save bandwidth, various ones of the service keys may be included in the same EMM rather than in separate EMMs. For instance, if a user subscribes to a service package that includes multiple services, all the service keys for the user can be delivered in one EMM message.

The IPPV key may be included in the EMM that includes the long-term key. In fact, the EMM that includes the long-term key(s) may also include multiple IPPV keys. The IPPV key or keys can be accommodated in the EMM in a variety of different ways. For instance, in the case of the service key update using the group key EMM, a field of variable length may contain all the IPPV keys. In addition to the keys themselves, this field may begin by specifying the number of IPPV keys that are included, using, for instance, one byte of data.

In addition to the IPPV key itself, the EMM may contain additional ancillary information that the client device needs in order to decrypt the IPPV content. For instance, when a user subscribes to an IPPV service, the client device is notified that it is provisioned for this service. However, even though the client device is provisioned for IPPV, the client device must still grant each IPPV purchase requested by the user. The granting of the purchase, even when IPPV privileges are allocated, depends upon the subscriber's current credit status, which is managed for the system operator by the conditional access system.

The credit status received in the EMM is stored within the secure module of the client device. Therefore, whenever a user requests an IPPV purchase, the client device will allow the purchase (i.e. the secure module will decrypt the traffic key for the requested event or program so that it can be subsequently decrypted.) only if the client device is holding sufficient unused credit for the subscriber. If the subscriber's debit values (also stored within the client device) are so nearly equal to the credit values that the client device is not holding enough unused credit to cover the cost of the requested program, the client device will disallow the purchase request. Thus, in order to maintain sufficient credit in the client device (and hence maintain the subscriber's right to make IPPV purchases), the client device needs to report the IPPV purchasing history to the conditional access system (CAS) through an available two-way channel (such as the Internet or PSTN). Based on the IPPV purchasing history, the CAS will request the billing system to charge the user for the IPPV purchases. The CAS can subsequently give the client device a credit update to increase the device's credit value based on the newly reported debit value. The credit update may also indicate the amount of purchased IPPV services that have been paid for. For example, assume the device is initially given 100 credit points and its debit value is 0. After watching some IPPV programs, the debit value is increased to 89. When it is reported to the CAS, the CAS will notify the billing system that it should charge the user for 89 points and update the device's credit value to 189 points to maintain 100 available credit points. In this way, the conditional access system keeps tracking the credit and debit values stored in the client device.

In one particular implementation an EMM message may also contain the current credit limit and the debit value, each of which may be represented, for instance, by 4 bytes of data. In addition to this current credit status information, in some cases the previous credit status also may be included in the EMM message that is sent to the device to update its credit limit for verification purposes.

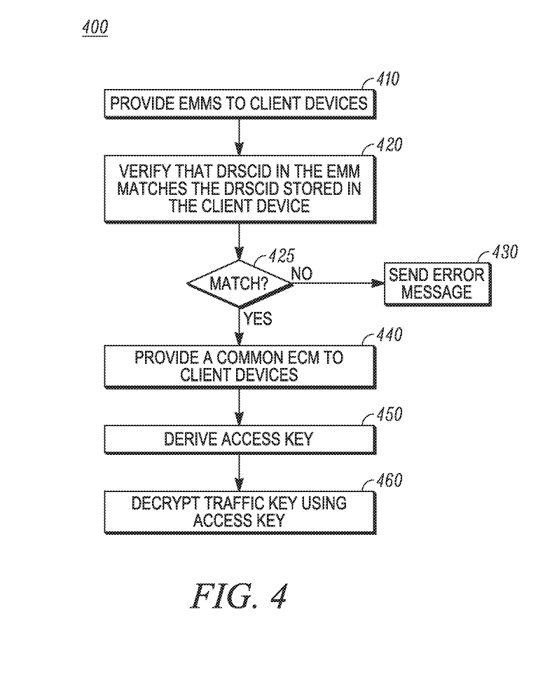

FIG. 4 illustrates a flow diagram of one example of a method 400 for providing authorized access to content to multiple client devices using system 100. It should be apparent to those of ordinary skill in the art that in the method 400, as well as other methods described herein, other steps may be added or existing steps may be removed, modified or rearranged without departing from the scope of the method 400. Also, the method is described with respect to the system 100 by way of example and not limitation, and the methods may be used in other systems.

In this example authorized access is provided to content for multiple devices using a single common ECM regardless of the fact that a user of each different client device may have different levels of access to the content. In other implementations, different ECM messages may be used for different client devices or groups of client devices.

At step 410, EMMs are provided to one or more client devices. The EMMs includes at least one service key for the one or more client devices and the DRSCID of the current DRS public key certificate. The EMMs are typically delivered uniquely to each of the multiple devices, with a service key corresponding to the purchased access model.

At step 420, each of the client devices verifies that the DRSCID contained in the EMM matches the DRSCID stored in the client device. If at decision step 425 it is determined that there is no match, the method proceeds to step 430, in which the client device sends an error message and the method terminates. If a two-way channel between the DRS server and the device is available, the DRS server may send the correct current DRS public key certificate to the client device, reporting the error by any appropriate means. If only a one-way channel is available, the client device has to wait for the next DRS certificate broadcast in order to obtain the current DRS certificate before it can proceed further. On the other hand, if at decision step 425 it is determined that there is a match, the method continues to step 440.

At step 440, an ECM is provided to the client devices. Although each of the various client devices may have different levels of access to the content, in this example the ECM provided to them is the same ECM for every client device. The ECM includes an encrypted traffic key for decrypting content.

At step 450, each of the client devices derives an access key using the service key (e.g., the PK) delivered in the EMM and information available from the ECM. For instance, a user who purchased a program will receive the PK in his EMM and will use it to derive the access key. A subscriber to the entire service will receive an LTK in his EMM and will have to derive the STK first, then the PK and finally the access key.

At step 460, each of the client devices uses the access key derived in step 450 to decrypt the traffic key(s) to access the content according to the access rules for the content. The access rules are obtained from the ECM and can be authenticated indirectly during the access key derivation process, since the derived access key will not be correct if the information is modified, and consequently the traffic key will not be correctly decrypted. In this example, the traffic keys are common to all the client devices and each of the service keys is used for access to the traffic key.

It should be noted that when the client device receives a new DRS certificate, it generally will not immediately erase or otherwise delete or make inaccessible the previous DRS certificate. Typically the DRS server will send out a new DRS certificate message to the client devices before it begins using the new DRS public key. If the current DRSCID received in the EMMs does not match the stored DRSCID value, the client device will first check to see if there is a new DRS certificate that has a DRSCID value which does match. If such a certificate is available, the new certificate will become the current, active certificate and its DRSCID becomes the current, active DRSCID as well. The previously current DRSCID becomes obsolete once the new DRSCID becomes the current and active version. In this way the DRS server and the client devices transition to a different DRSCID. When the client device receives a DRS certificate, it compares its DRSCID to the stored DRSCID. If the DRSCID in the newly received certificate is older than or the same as the stored DRSCID, then the newly received certificate is ignored. If on the other hand it is a more recent or newer certificate, the client device stores it. The older certificate will remain current until the EMM messages start to use the new DRSCID.

In the aforementioned examples the different levels of access to the content include a long-term subscription, a short-term subscription, and access to a single program. The short-term subscription has a shorter period of subscription than the long-term subscription, such as a weekly subscription or a daily subscription, whereas the long-term subscription has a monthly subscription or a yearly subscription. As previously mentioned, examples of the service key are the long-term key (including the IPPV key) 210, the short-term keys 230, and the program key 250 in FIG. 3. In one example, a level of access to content provides access to a predetermined amount of content (e.g., a predetermined number of channels or programs) and/or access to a predetermined amount of time of content during which the content will be available (e.g., monthly subscription to a basic channel package or a premium channel package). Also, a fee or cost may be associated with each level (also referred to as access type) of access. For example, there may be different fees for a monthly subscription, a weekly subscription, a PPV and an IPPV.

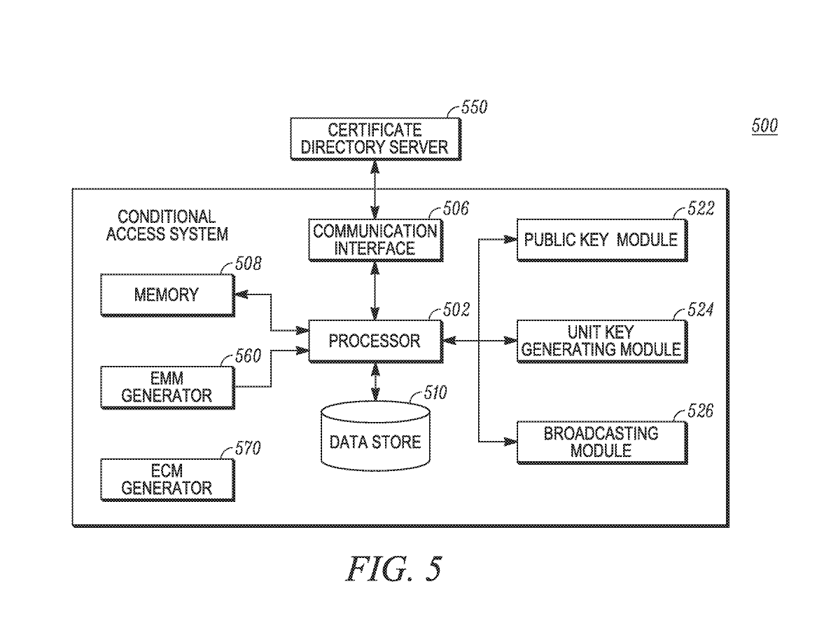

FIG. 5 shows one example of the pertinent components of a conditional access system 500. The conditional access system may be incorporated into a content delivery system such as the content delivery system 100 discussed in connection with FIG. 1. For example, if the content delivery system is a cable data system, the conditional access system 500 may be incorporated in or otherwise associated with the cable headend. It should be apparent to those of ordinary skill in the art that FIG. 5 is a block diagram that represents a generalized illustration and that other components may be added or existing components may be removed, modified or rearranged.

The conditional access system 500 includes a processor 502, a communication interface 506, a memory 508, a data store 510, a public key module 522, a unit key generating module 524, an EMM generator 560, and ECM generator 570 and a broadcasting module 526. As also shown in FIG. 5, the conditional access system 500 is in communication with a certificate directory server 550 over a network (not shown), such as the Internet or an internal network. The certificate directory server 550 provides the certificates and the public key of the devices. The public key module 522 may retrieve the device public key from the certificate directory server 550 over the network. The modules 522-526 may comprise software modules, hardware modules, or a combination of software and hardware modules. Thus, in one embodiment, one or more of the modules 522-526 may comprise circuit components. In another embodiment, one or more of the modules 522-526 may comprise software code stored on a computer readable storage medium, which are executable by the processor 502. In a further embodiment, the modules 522-526 may comprise a combination of hardware and software. In any regard, the functionalities of one or more of the modules 522-526 may be combined into a lesser number of modules 522-526 or separated into additional modules without departing from a scope of the invention.

The memory 508 and the data store 510 may comprise any reasonably suitable computer readable storage media, such as, RAM, ROM, EPROM, EEPROM, magnetic or optical disks or tapes, etc. The memory 508 may store respective programs or algorithms that define the functionalities of the processor 502. In this regard, in instances where the modules 522-526 comprise software modules, the modules 522-526 may respectively be stored as software on the memory 508. The data store 510 may store various information that the processor 502 may need to access such as the private/public key pair of the device registration server 110.

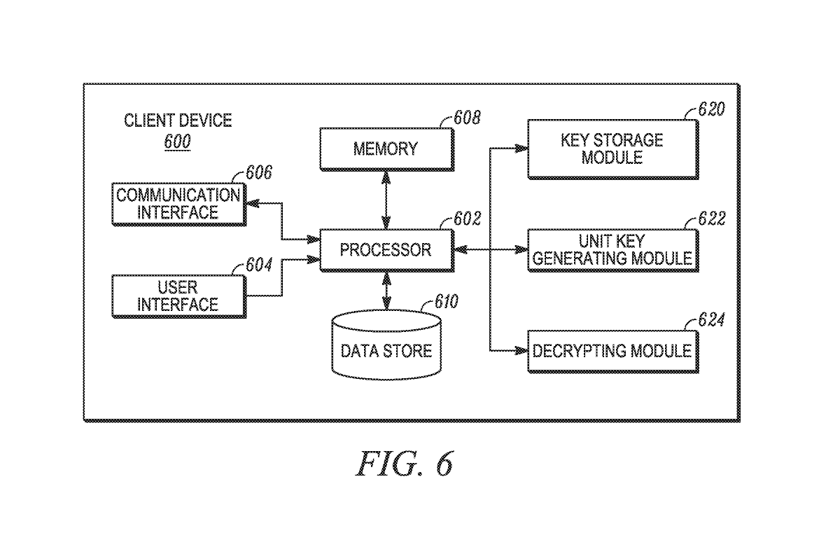

FIG. 6 shows one example of the pertinent components of a client device 140. It should be apparent to those of ordinary skill in the art that FIG. 6 is a block diagram that represents a generalized illustration and that other components may be added or existing components may be removed, modified or rearranged. The client device 140 includes a processor 602, a user interface 604, a communication interface 606, a memory 608, a data store 610, a key storage module 620, a unique key generating module 622, and a decrypting module 624.

The key storage module 620 stores the various cryptographic keys that are both initially provisioned in the client device 140 and delivered to the client device 140 over the content delivery system via the EMMs and the like. The unique unit key generating module 622 derives the client device's unit key from its private key and the DRS public key, both of which are stored in the storage module 620. The decrypting module 624 is employed to decrypt the various service keys received in the EMMs using the user key, to derive the access key from the service key and to decrypt the traffic key.

The modules 620-624 may comprise software modules, hardware modules, or a combination of software and hardware modules. Thus, in one embodiment, one or more of the modules 620-624 comprise circuit components. In another embodiment, one or more of the modules 620-624 comprise software code stored on a computer readable storage medium, which are executable by one processor 602. In a further embodiment, the modules 620-624 may comprise a combination of hardware and software. In any regard, the functionalities of one or more of the modules 620-624 may be combined into a lesser number of modules 620-624 or separated into additional modules without departing from a scope of the invention.

The modules 620-624 may be implemented as one more secure hardware modules that are not susceptible to tampering. For instance, in some implementations the modules 620-624 may be implemented on a tamper resistant silicon microchip. The modules 620-624 may include their own dedicated secure processor(s) that handles the processing functions for the secure hardware module such as the execution of the decryption functions. Alternatively, software obfuscation and transformation techniques may be employed so that these processes can be securely executed even on the main processor 602. In yet other implementations the modules 620-624 may be implemented as a smart card module that is used to receive a smart card on which is encoded a computer-readable data structure for the access key hierarchy 200 for execution by the smart card module. Alternatively, a combination of a smart card module and a hardware security module may be used.

The user interface 604 may comprise a set of keys, buttons, switches, audio transducers, displays and the like through which a user may enter inputs into the client device 140. The communication interface 606 may comprise suitable hardware and/or software to enable the client device 140 to communicate over the content delivery system.

The memory 608 and the data store 610 may comprise any reasonably suitable computer readable storage media, such as, RAM, ROM, EPROM, EEPROM, magnetic or optical disks or tapes, etc. The memory 608 may store respective programs or algorithms that define the functionalities of the processor 602. In this regard, in instances where the modules 620-624 comprise software modules, the modules 620-624 may respectively be stored as software on the memories 608. The data store 610 may store various information that the processor 602 may need in addition to the various keys available in the storage module 620. For instance, the data store 610 may store the DRSCID obtained from the DRS public key certificate if it is not otherwise stored in the key storage module 620. Likewise, the storage module 620 may store, temporarily in some cases, the DRSCID obtained from the EMMs so that the various values of the DRSCID may be compared by the processor 602. Another example of information that may be stored in the data store 610 may include the IPPV credit status.

Although various embodiments are specifically illustrated and described herein, it will be appreciated that modifications and variations of the present invention are covered by the above teachings and are within the purview of the appended claims without departing from the spirit and intended scope of the invention. For example, while the invention has been described in the context of a conditional access system, which protects content by requiring certain criteria to be met before granting access to content, the invention is also applicable to copy protection schemes, which prevents the unauthorized reproduction of content.

What is claimed is:

1. A method for a client device to obtain authorized access to content delivered over a content delivery network, comprising:
receiving an entitlement management message (EMM), said EMM including at least one cryptographic key and a device registration server certificate ID (DRSCID) identifying a currently valid device registration server (DRS) public key certificate;
comparing the DRSCID obtained from the EMM to a stored DRSCID value;
receiving an entitlement control message (ECM), wherein the ECM includes an encrypted traffic key for decrypting content; and
if the DRSCID obtained from the EMM is determined to match the stored DRSCID;
decrypting the traffic key with the cryptographic key or a key derived from the cryptographic key to thereby access the content.

2. The method of claim 1 wherein the cryptographic key is a service key associated with a service available over the content delivery network.

3. The method of claim 2 further comprising:
deriving an access key from the service key and access rules if the DRSCID obtained from the EMM is determined to match the stored DRSCID; and
decrypting the traffic key with the access key.

4. The method of claim 2 wherein the service key is encrypted by a unit key and further comprising:
deriving the unit key from a private key associated with the client device and a DRS public key obtained from the DRS public key certificate; and
decrypting the service key with the unit key.

5. The method of claim 2 wherein the service key includes a hierarchy of service keys that each define a level of service available to the client device and further comprising deriving a service key lower in the hierarchy with a service key higher in the hierarchy and deriving the access key from a service key lowest in the hierarchy.

6. The method of claim 1 wherein the cryptographic key is a long-term key.

7. The method of claim 6 wherein the long-term key is encrypted with a group key that is delivered to a plurality of client devices having a common subscription plan.

8. The method of claim 1 wherein the DRSCID includes an identifier and a revision number specifying a version of the DRS public key certificate, and wherein comparing the DRSCID obtained from the EMM to the stored DRSCID value further comprises comparing the revision number of the DRSCID obtained from the EMM to the revision number of the stored DRSCID value.

9. The method of claim 1 wherein the cryptographic key includes at least a long term key and a plurality of other service keys that are respectively identified in a service key list by a long term interval ID and a plurality of service IDs.

10. The method of claim 7 wherein the EMM message includes an IPPV key.

11. The method of claim 10 wherein an EMM that delivers the service key has a variable length field in which the service key and IPPV key are located.

12. The method of claim 2 wherein an EMM that delivers a DRS certificate has a variable length field to accommodate additional cryptographic and configuration information.

13. The method of claim 1 wherein at least one of the cryptographic keys is a group key delivered to a plurality of client devices having a common subscription plan.

14. The method of claim 9 wherein the service IDs for the service key IDs all include the long term interval ID.

15. A system configured to facilitate authorized access to content delivered to a plurality of client devices over a content delivery system, comprising:
a client device registration server configured to broadcast to the client devices DRS public key certificates each containing a public key of the client device registration server and a DRSCID identifying the DRS public key certificate;
an entitlement management message (EMM) generator configured to provide EMMs to the client devices, each EMM including a service key or a list of service keys and a DRSCID identifying a currently valid DRS public key certificate that has been broadcast to the client devices; and
an entitlement control message (ECM) generator configured to provide ECMs to the client devices over the content delivery system, wherein each ECM includes an encrypted traffic key for decrypting content, wherein the encrypted traffic key is configured to be decrypted by an access key derived at least in part from the service key and the public key of the client device registration server.

16. The system of claim 15 wherein the currently valid DRS public key certificate is a DRS public key certificate that includes a public key that is part of a DRS public/private key pair having a private key that is current being used by the client device registration server to derive a unique unit key associated with each of the client devices.

17. The system of claim 16 wherein further comprising a unique unit key generating module for generating the unique unit key associated with each of the client devices from the private key currently being used and a public key respectively associated with each of the client devices.

18. The system of claim 15 wherein the ECM generator is further configured to provide to each of the client devices a common ECM containing a common encrypted traffic key.

19. The system of claim 15 wherein the EMM generator is configured to provide different EMMs to different client devices such that each client device obtains a different level of access to the content.

20. A client device configured to access content from a content delivery system, comprising:
a storage medium for storing a DRS public key certificate that includes a DRS public key and a DRSCID identifying the DRS public key certificate, a device certificate and a device private key;
one or more modules configured to receive a first message containing a cryptographic key and a DRSCID identifying a currently valid DRS public key certificate and a second message containing an encrypted traffic key for decrypting the content;
a unit key generating module configured to generate a unique unit using a cryptographic function on a private key of the client device and the DRS public key contained in the DRS public key certificate;
a processor configured to compare the DRSCID contained in the first message to the stored DRSCID value;
a decrypting module configured to (i) derive an access key from the cryptographic key if the DRSCID contained in the first message matches the stored DRSCID value (ii) to decrypt the encrypted traffic key using the access key and (iii) to decrypt the content using the traffic key.

21. The client device of claim 20 wherein the cryptographic key is a service key associated with a service available to the client device over the content delivery system.

22. The client device of claim 21 wherein the service key includes a hierarchy of service keys that each define a level of service available to the client device and the decrypting module is further configured to derive a service key lower in the hierarchy with a service key higher in the hierarchy and derive the access key from a service key lowest in the hierarchy.
